(19) United States
(12) Patent Application Publication
(10) Pub. No.: US 2026/0038224 A1
(43) Pub. Date: Feb. 5, 2026

(54) Aerial Polarization-Imaging System and Method for Detection of Subsurface Marine Life

(71) Applicant: Vincent Loccisano, Wellesley, MA (US)

(72) Inventor: Vincent Loccisano, Wellesley, MA (US)

(21) Appl. No.: 19/357,968

(22) Filed: Oct. 14, 2025

(51) Int. Cl. G06V 10/147; G02B 5/30; G06T 7/246; G06T 7/50; G06V 20/05; G06V 40/10

(52) U.S. Cl. CPC G06V 10/147; G06T 7/246; G06T 7/50; G06V 20/05; G06V 40/10; G02B 5/30; G06T 2207/10032

(57) ABSTRACT

An aerial polarimetric fish-detection system and method acquire polarization-resolved imagery from an elevated platform over a water area, compute per-pixel polarization metrics (degree and angle of linear polarization), compensate for viewing geometry and environmental factors, and detect candidate subsurface scatterers consistent with fish via spatial and temporal anomaly analysis. The system geolocates candidate fish positions, estimates confidence and depth proxies, and add more details about how the polarization may happen to allow seeing below the surface and reducing glare.

### TECHNICAL FIELD OF THE INVENTION

The present invention relates generally to the field of remote sensing and environmental monitoring. More specifically, it pertains to an aerial system and method for the detection and localization of fish and other biological entities residing beneath the surface of a body of water.

### BACKGROUND OF THE INVENTION

The detection of aquatic life is seen in various fields including commercial fishing, recreational angling and ecological research. Traditional methods include visual observation from a boat or aircraft and acoustic methods. Sound Navigation and Ranging (SONAR) is widely used in commercial and recreational fish finding products. While SONAR can detect objects in a water column and provide depth information it typically has a limited field of view, offering data only for the area directly beneath a SONAR transducer. Acoustic methods are less effective in shallow waters and are unable to provide visual confirmation of classification of the detected targets.

Although the advent of Unmanned Aerial Vehicles (UAVs) or drones, there has been a growing interest in using conventional aerial imaging for fish spotting using standard cameras. These systems suffer from the same fundamental limitations as direct visual observation including surface glare and water surface turbidity.

### SUMMARY OF THE INVENTION

The present disclosure describes an aerial system designed for the detection of fish and other subsurface aquatic life. A system uses an aerial platform to carry a specialized imaging payload over a body of water. The aerial platform may be a hot-air balloon, kite, drone or the like. The aerial system overcomes the limitations of conventional imaging which is often hampered by surface glare and water turbidity, by analyzing the polarization of light reflected from the water and objects within it.

The imaging payload is equipped with at least one image sensor capable of capturing polarization-resolved imagery. Polarization-resolved imagery is produced by a technique that involves measuring the orientation of light waves and capturing two or more polarization angles for each pixel. This can be achieved either with a specialized camera that captures multiple polarization channels simultaneously or with a standard camera paired with a rotating or variable polarizing filter that captures sequential images at different angles. This data allows the system to perceive qualities of reflected light that are invisible to the naked eye or standard cameras.

A processing module receives the polarization-resolved imagery and computes key polarization metrics including the degree and angle of linear polarization. The system is programmed to identify anomalies in these metrics that are consistent with light scattering off biological entities, thereby detecting potential fish. For each pixel, the system calculates polarization metrics including the Degree of Linear Polarization (DoLP) and the Angle of Linear Polarization (AoLP). The system is configured to recognize specific polarization signatures such as those that scatter off fish to define candidate subsurface biological scatterers.

Polarized aerial imaging is highly effective for detecting animals at or near the water's surface, particularly those with wet, specularly reflective bodies. Under favorable conditions, such as clear to moderately turbid water and optimal sun-sensor geometry, it can identify schools of fish, surfacing marine mammals, waterfowl, turtles, and even large invertebrates or prey patches. While this method is robust for detection and coarse classification, identifying specific species requires more advanced techniques, including targeted calibration, combined multispectral and polarimetric data, and extensive ground-truth datasets.

The effectiveness of polarized aerial imaging for detecting aquatic animals is governed by a clear set of environmental and physical principles. The technique is most successful when animals are at or near the surface, within the optical penetration depth of the water. Detectability diminishes significantly with increasing depth, water turbidity, and surface roughness from wind or waves. The strongest polarized signals are generated by animals with wet, reflective (specular) surfaces, such as the oriented scales of a fish, the glossy plumage of waterfowl, or the smooth, wet skin of a marine mammal. Consequently, the practical detection depth is highly conditional, ranging from a few meters in very clear water to only the top few centimeters in moderately turbid conditions, with subsurface detection being nearly impossible in highly turbid environments.

This capability extends across a wide range of taxa, provided these conditions are met. It is particularly adept at identifying schools of near-surface fish like mackerel, sardines, and herring, which produce a coherent polarized contrast from their collective specular reflections. Large, solitary animals are also highly detectable; the brief surfacing and breaching behaviors of cetaceans (dolphins and whales) expose dorsal fins and bodies that create high-contrast signatures. Similarly, the smooth carapaces of sea turtles, the wet fur of seals near the surface, and the dorsal surfaces of crocodilians produce distinct polarization anomalies. The method is also applicable to waterfowl on the water, and even large invertebrates like squid or crustaceans when they are very close to the air-water interface.

Beyond direct detection of individual animals, this technology can be used to identify broader ecosystem signals, such as dense prey patches or plankton blooms that alter the scattering properties of the water and indicate predator foraging areas. However, while distinguishing between coarse groupings-such as a dolphin versus a school of fish-is feasible, achieving reliable species-level identification is far more challenging. This advanced level of discrimination requires combining polarimetric data with multispectral imagery, extensive ground-truth datasets, and robust calibration. For optimal results, surveys should prioritize taxa that frequent clear, shallow water and exhibit frequent surfacing behavior. Combining polarization data with high-frame-rate cameras for fast-moving targets and integrating it with other data sources, like known behavioral patterns, will yield the most accurate and insightful results.

The system may compensate for variables such as the sun's position, azimuth and elevation, and the platform's viewing angle. The system may also analyze a sequence of images to detect movement patterns characteristic of swimming fish thus aiding in confirming a target and to reduce false positive outcomes. Further refinements include a module that assesses water surface roughness from wind and waves to automatically adjust detection sensitivity to match conditions. In one embodiment the effect of waves and the glare associated with the waves is compensated for and removed. One skilled in the art is familiar with noise cancelling headphones and in a similar manner wave interference is canceled from an image. Wave slopes are estimated by analyzing an AoLP image an algorithm can create a slope map of the ocean surface. Using the slope map and the known physics of reflection the algorithm calculates the glare component should be for each pixel. A synthetic image is generated that contains only the bright and dark patterns of the waves caused by reflected light. The synthesized wave-only glare is subtracted from the original image. The result is an image dominated by the unpolarized, subsurface light. Wave patterns that existed entirely in the glare component are removed. The resulting image appears as though looking through a calm flat water surface.

Once a potential fish or group of fish is identified the system generates the georeferenced location of the fish along with a confidence score and an estimated depth range. The information is then sent to a user interface, which may display the targets on a map and may recommend optimal casting points for anglers, providing a significant advantage in locating and catching fish.

### BRIEF DESCRIPTION OF DRAWINGS

FIG. 1 is a perspective view of an example embodiment;

FIG. 2 is a perspective view of an example map showing sun vector, viewer vector, water surface normal, polarization filter angle and captured components;

FIG. 3 is a plan view depicting an example orthorectified polarization-derived detection overlay on water body showing candidate fish positions and confidence heatmap.

FIG. 4 is diagram depicting Processing pipeline: capture at multiple polarization angles→radiometric correction→geometric correction→compute Stokes/DoLP/AoLP→detection & classification→geolocation & UI output.

FIG. 5 is a diagram depicting an iteration of a processing pipeline: positioning an imaging payload→capturing polarization-resolved imagery→receiving data in a processing module→computing per-pixel polarization metrics→identifying candidate subsurface scatterers→deploying internal resources→outputting georeferenced data.

FIG. 6 is a perspective view of a specialized polarizing camera.

### DETAILED DESCRIPTION OF THE INVENTION

Example embodiments use polarization imaging from an elevated vantage to reduce surface glare and to accentuate subsurface scattering signatures produced by fish. Subsurface scattering signatures include specular and diffuse backscatter from fish bodies and wakes. The imaging system acquires polarized images at multiple analyzer angles or uses a polarization camera to sample polarization states in a single capture, then computes polarization metrics for example, Stokes vector components, degree of linear polarization (DoLP), angle of linear polarization (AoLP) and the like. Processing compensates for viewing geometry such as sun elevation and azimuth, sensor viewing angle, water surface polarization behavior (Fresnel reflection), and environmental factors such as wind, waves, and turbidity, to isolate subsurface polarization signals associated with targets below the surface

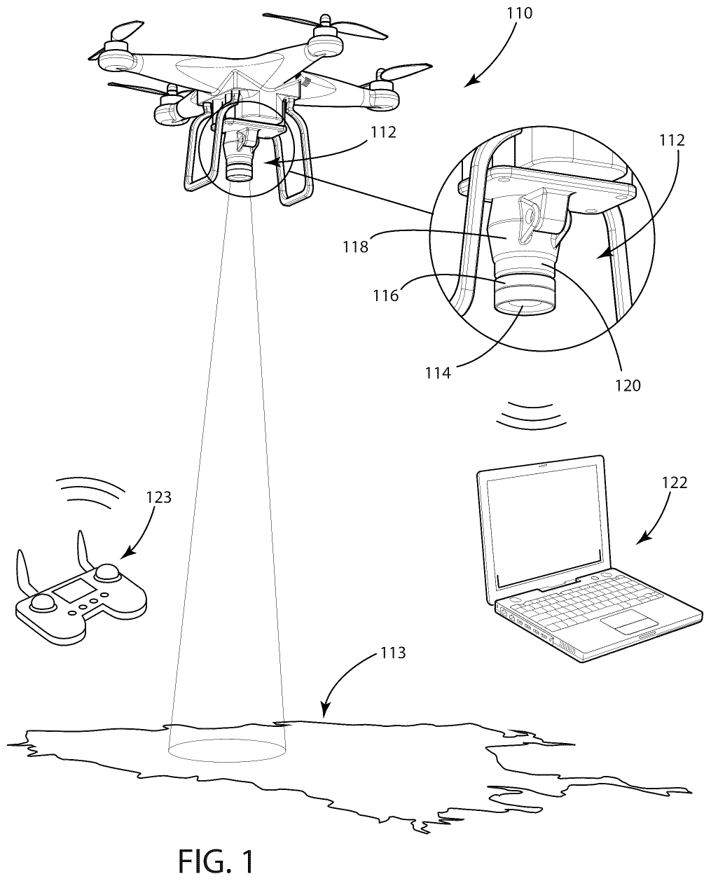

In FIG. 1 a UAV 110 is depicted over a target area 113. One skilled in the art understands that any aerial vehicle capable of maintaining position and altitude over a target area 113 may be used. A drone 110 is depicted in this example. In some embodiments typical altitudes are between 5 and 100 m AGL depending on the specific UAV. A platform may include GNSS/RTK for georeferencing, IMU for orientation and communications link to a ground controller 123 or to a processor and display unit 122 or to cloud processing that in turn is displayed on the display unit 122.

An imaging payload 112 is a camera with a polarizer 116 engaged with a camera lens 114. a navigation and control module 118 positions and orients the imaging payload to acquire images at one or more polarization angles and exposure settings. A processing module may be onboard the UAV 110 or may be in a computer 122 with wireless communication to and from the imaging payload 110. The processing module 122 receives polarization features such as degree and angle of linear polarization, also referred to as Stokes Parameters. In some embodiments the polarizer 116 is a rotating linear polarizer providing stepwise acquisition at multiple analyzer angles, e.g., e.g., 0°, 45°, 90°, 135°, by rotating the polarizing element between exposures or continuous rotation with synchronized capture. In other embodiments a switching polarization filter assembly is an electronically switchable linear polarizer (liquid crystal variable retarder+polarizer) configured to capture multiple polarization states rapidly without mechanical rotation. In yet other embodiments the polarizer is a polarization-resolving camera: division-of-focal-plane (DoFP) or division-of-amplitude polarimeters providing simultaneous per-pixel polarization channels, e.g., 0°, 45°, 90°, 135° microgrid. In yet other embodiments multispectral or near-infrared band channels are co-registered with polarization channels for improved discrimination. Further additional sensors 120 may include downward-facing sun sensor or use of ephemeris/time/GNSS and IMU to compute sun vector; wind sensor for assistance in wave estimation; optional bathymetry or depth map input if available.

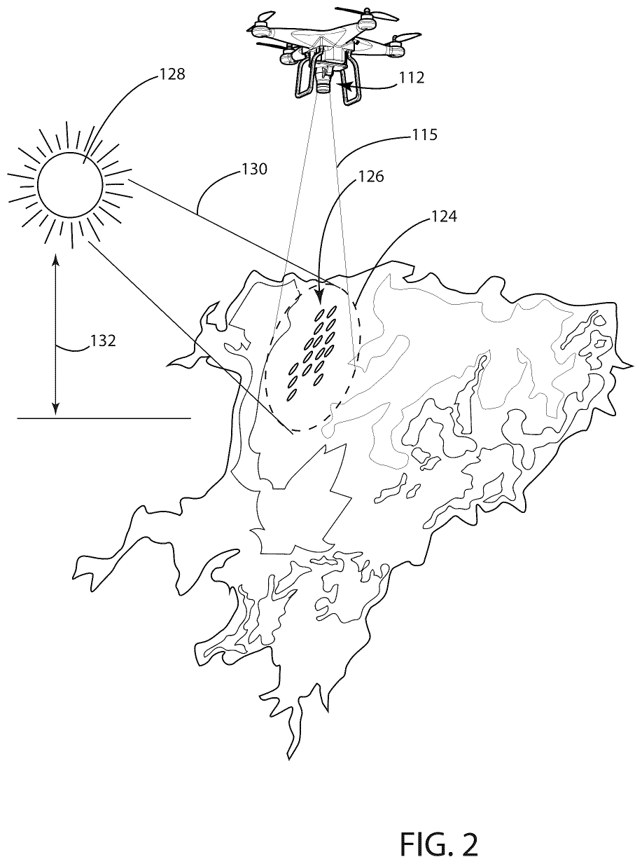

An example use of the system is depicted in FIG. 2. An acquisition altitude and camera field-of-view 115 is chosen to cover an intended detection area 124 with required ground sample distance (GSD). In some embodiments a GSD may be between 1-10 cm/pixel depending on desired detection size. Polarization resolved imagery 124. is captured. For rotating/switching polarizer approaches, a rapid sequence of images is captured at distinct analyzer angles with exposure compensation to avoid motion artifacts. A sun 128 vector 130 is calculated based on the sun elevation 132, and view angle. Glint regions and polarization contrast is considered by computing DoLP and AoLP. In some cases repeated passes or continuous video capture is performed for temporal analysis and motion-based corroboration. Spatial filters and anomaly detectors are applied to polarization-feature maps to locate candidate subsurface scatterers 126 that exhibit polarization signatures consistent with fish. One skilled in the art understands that this may be determined by localized reduced DoLP shifts in AoLP intensity anomalies sympatric with DoLP changes. Multi-frame temporal analysis is used to track candidate markers 126 across frames to detect autonomous motion indicative of fish swimming and wake signatures or repeated appearance. Temporal differencing helps suppress false positives from static subsurface objects. Polarization features are then combined with intensity, color, texture, motion and optional multispectral cues in a classification model to estimate probability that a candidate is fish and to estimate approximate size and depth. Relative depth is determined from attenuation and polarization shift calibrated to the specific site. In some embodiments, estimated georeferenced coordinates for candidate locations along with estimated depth range, approximate fish size and recommended casting points relative to shore or boat are calculated and displayed.

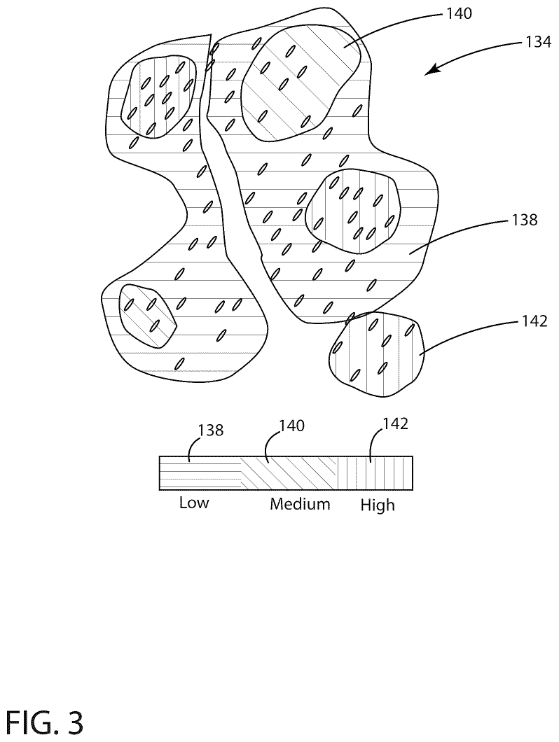

An example of confidence metrics is depicted in the illustration in FIG. 3. One skilled in the art understands that color representations may also be used. The present image is a black and white line drawing representing color areas. Areas of low confidence 138 are shaded with horizontal lines, areas of medium confidence 140 are shown in diagonal lines and areas of high confidence are shaded in vertical lines on a map 134 showing candidate scatterers and the relative confidence.

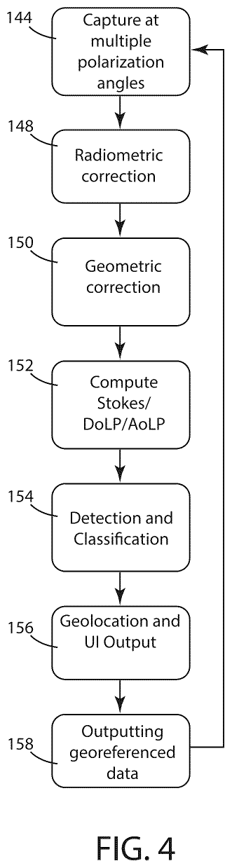

FIG. 4 is a diagram depicting a processing pipeline. Polarization-resolved frames with pose/time metadata are captured 144 and radiometric correction 148 is accomplished by polarimetric calibration to register frames. This may also include lens vignetting compensation. The process continues with geometric correction 150 that may also include georectification using platform pose (GNSS/IMU) for per-pixel geolocation. The process follows by computing per-pixel I,Q,U and computing Stokes/DoLP/AoLP per band 152 and by registration of multi-angle polarization frames to sub-pixel alignment when sequential acquisition is used. In an example use, Stokes parameters (I,Q,U) per-pixel from polarization channel images may be calculated as:

$$I = I 0 + I 90 ( or equivalent depending on sensor )$$

$$Q = I 0 - I 90$$

$$U = I 45 - I 135$$

An example calculation of the degree of linear polarization is as follows: DoLP=sqrt(Q\hat{ }2+U\hat{ }2)/I and angle of linear polarization AoLP=0.5*atan2(U, Q)

The process follows by detecting and classifying 154 pixels/blobs as subsurface biological targets if the feature vector exceeds threshold or ML probability. The process continues with geolocation and UI output 156 and concludes by outputting georeferenced data 158. In some embodiments the process may also use sun/platform geometry +Fresnel model to predict surface polarization in order to subtract or weight down surface term and may also compute local DoLP contrast and AoLP deviation and temporal motion features.

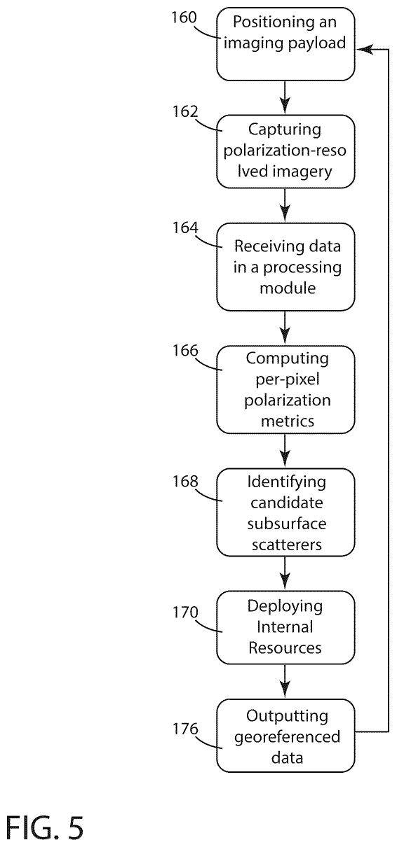

FIG. 5 is a diagram of an additional embodiment of a processing pipeline. The process begins by positioning an imaging payload 160 over a watery area and capturing polarization-resolved imagery 162. The polarization-resolved imagery is received in a processing module 164 where the processor computes per-pixel polarization metrics 166 and identifying candidate subsurface scatterers 168. Once chosen subsurface scatterer data is chosen the process continues by deploying internal resources 170 and the process completes by outputting georeferenced data 176. Georeferenced data may include waypoints to the scatterer location.

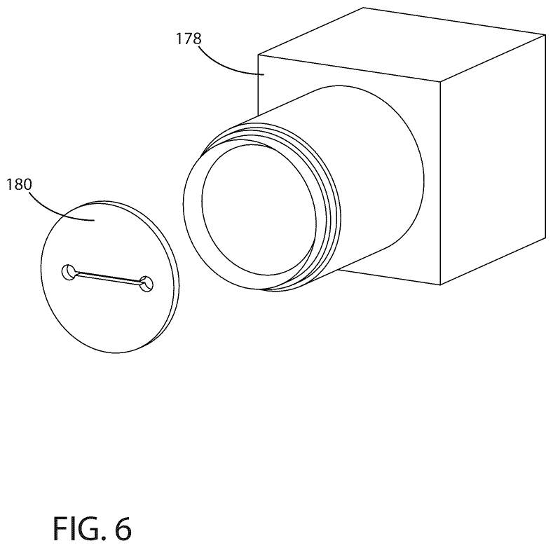

FIG. 6 is a perspective view of a specialized polarizing camera that is part of the imaging payload in some embodiments. A specialized camera 178 that captures multiple polarization channels simultaneously through a polarization filter 180. In this example embodiment a linear polarizer 180 transmits linearly polarized light into the camera lens thus reducing reflections to allow subsurface scatterers to be visible.

In some embodiments optional water surface masking is performed to detect and mask non-water regions such as shoreline vegetation, vessels and the like using color or texture segmentation or auxiliary maps. Other options include compensation for waves and wind wherein the process estimates surface roughness from image texture, IMU and wind sensor data wherein it then adapts detection thresholds accordingly and my downweight high-glint frames. If water attenuation is known or measured the process may adjust expected polarization signatures for depth attenuation and spectral response and may optionally combine with turbidity sensor or historical water quality data. For sun geometry compensation the process may use sun azimuth/elevation to predict polarization patterns of surface reflections and subtract modeled surface polarization to reveal subsurface contributions.

In other embodiments a user interface presents a georeferenced map overlay with candidate fish locations, estimated confidence, and suggested user actions. including best casting points, recommended lure depth/range, recommended approach path or suggested waypoint for boaters. The user interface may also provide temporal updates and alerts when new detections or confidence is updated. Further a user interface may allow a user selection of detection confidence threshold, species-size filters and exclusion zones. The user interface may also provide logging for later review, shareable waypoints and optional automatic route guidance to waypoints.

1. An aerial polarimetric subsurface-biological detection system comprising:
an aerial platform configured to hold an imaging payload at an altitude above a target water area; and
an image payload mounted to the aerial platform, the imaging payload comprising:
at least one image sensor configured to capture polarization-resolved imagery of the target water area; wherein
polarization-resolved imagery comprises:
two or more polarization analyzer angles per pixel; and
a processing module in communication with the imaging payload and configured to:
receive the polarization-resolved imagery, compute per-pixel polarization metrics comprising at least a degree of linear polarization and an angle of linear polarization; and
identify one or more candidate subsurface scatterers within the target water area by detecting spatial or temporal anomalies in the polarization metrics consistent with subsurface-biological scatterers; and
output georeferenced candidate locations and associated confidence scores to a user interface.

2. The system of claim 1 wherein:
the imaging payload comprises a polarization-resolving camera that simultaneously captures at least two polarization channels per pixel.

3. The system of claim 1 wherein:
the imaging payload comprises:
a camera and a variable linear polarizing filter assembly configured to capture sequential images at multiple analyzer angles.

4. The system of claim 1 wherein:
the processing module is further configured to compensate the polarization metrics for viewing geometry using input comprising sun azimuth, sun elevation and a pose of the aerial platform.

5. The system of claim 1 wherein:
the processing module is further configured to perform temporal analysis across a plurality of image frames to corroborate the one or more candidate subsurface scatterers by detecting motion consistent with swimming fish.

6. The system of claim 1 further comprising:
a user interface configured to display the georeferenced candidate locations on a map and to generate recommended casting points based on said locations.

7. The system of claim 1 wherein:
the processing module is further configured to estimate an approximate depth range for a candidate subsurface scatterer using attenuation-corrected polarization and intensity features derived from the polarization resolved imagery.

8. The system of claim 1 further comprising:
a wind and wave estimation module configured to compute a surface-roughness metric; and wherein
the processing module is further configured to adjust one or more detection thresholds based on the computed surface-roughness metric.

9. The system of claim 1 wherein:
the aerial platform is an unmanned aerial vehicle.

10. A method for detecting subsurface aquatic life, the method comprising the steps of:
positioning an imaging payload on an aerial platform above a target water area; and
capturing polarization-resolved imagery of the target water area using the imaging payload, wherein the imagery comprises at least two polarization analyzer angles per pixel; and
receiving the polarization-resolved imagery at a processing module; and
computing, by way of the processing module, per-pixel polarization metrics comprising a degree of linear polarization and an angle of linear polarization; and
identifying, by way of the processing module, one or more candidate subsurface scatterers by detecting anomalies in the polarization metrics consistent with biological entities; and
outputting georeferenced locations of the identified candidate subsurface scatterers to a user.

11. The method of claim 10 further comprising:
compensating the polarization metrics for sun position and viewing geometry prior to detection.

12. The method of claim 10 further comprising:
performing temporal tracking of detected candidates across successive frames and suppressing static false positives.

13. The method of claim 10 further comprising:
estimating an approximate target depth using calibrated attenuation models and presenting an estimated depth with each candidate.

14. A non-transitory computer-readable medium storing instructions that, when executed by one or more processors, cause the one or more processors to: receive polarization-resolved imagery captured from an elevated platform over a water area; compute per-pixel polarization metrics; detect candidate subsurface scatterers by applying spatial and temporal anomaly detection to the polarization metrics; and output georeferenced candidate locations and confidence scores.
